(19) United States
(12) Patent Application Publication
(10) Pub. No.: US 2016/0281917 A1
(43) Pub. Date: Sep. 29, 2016

(54) SUPPORT SYSTEM

(71) Applicants: Richard B. Murphy, San Diego, CA (US); Barbara H. Murphy, San Diego, CA (US)

(72) Inventors: Richard B. Murphy, San Diego, CA (US); Barbara H. Murphy, San Diego, CA (US)

(21) Appl. No.: 15/078,985

(22) Filed: Mar. 23, 2016

Related U.S. Application Data
(60) Provisional application No. 62/136,814, filed on Mar. 23, 2015.

(51) Int. Cl. F16M 13/02; E04G 5/00; A47B 96/06

(52) U.S. Cl. CPC F16M 13/02; A47B 96/06; E04G 5/00

(57) ABSTRACT

The present invention provides a frame comprising at least one transverse aperture and at least one vertical support aperture said transverse aperture configured to closely receive at least one board. The invention further provides an apparatus comprising a frame, said frame comprising at least one transverse aperture and at least one vertical support aperture, said transverse aperture configured to closely receive at least one board, and a frame locating means. The invention further provides an apparatus comprising a frame, said frame comprising at least one transverse aperture and at least one vertical support aperture, said transverse aperture configured to closely receive at least one board, one or more frame locating means and one or more vertical supports. The present invention provides an apparatus for maintaining a board in a horizontal elevated position comprising a frame to receive said board, at least one vertical support and at least one frame locating means to maintain the frame in position relative to the vertical supports. In one embodiment, the present invention enables the construction of elevated platform systems of custom dimensions, such platform systems incorporating standard building materials.

### RELATION TO OTHER APPLICATIONS

This application is related to and claims the benefit pursuant to 35 U.S.C. 119 of U.S. Provisional Patent Application Ser. No. 62/136,814 filed Mar. 23, 2015.

### BACKGROUND OF THE INVENTION

There are a variety of elevated platform (e.g. shelving and scaffolding) systems known in the art. Typically, such commercially available shelving systems are designed for use with manufactured shelves having specific dimensions. However, such standardized shelf sizes do not meet the requirements of many spatial constraints. Additionally, typical scaffolding is provided as a network of steel tubes with boards simply laid on the top of the tubing. Such scaffolding systems fail to restrain the vertical or horizontal motion of the boards. Thus, the scaffolding boards are prone to shifting or tilting resulting in hazardous conditions. Consequently, there is a need in the art for a system that enables the construction of elevated platform systems (e.g. shelving or scaffolding) of flexible dimensions that provides vertical and horizontal location of the materials comprising the platform.

### SUMMARY OF THE INVENTION

The present invention provides a frame comprising at least one transverse aperture and at least one vertical support aperture said transverse aperture configured to closely receive at least one board. The invention further provides an apparatus comprising a frame, said frame comprising at least one transverse aperture and at least one vertical support aperture, said transverse aperture configured to closely receive at least one board, and a frame locating means. The invention further provides an apparatus comprising a frame, said frame comprising at least one transverse aperture and at least one vertical support aperture, said transverse aperture configured to closely receive at least one board, one or more frame locating means and one or more vertical supports. The present invention provides an apparatus for maintaining a board in a horizontal elevated position comprising a frame to receive said board, at least one vertical support and at least one frame locating means to maintain the frame in position relative to the vertical supports. In one embodiment, the present invention enables the construction of elevated platform systems of custom dimensions, such platform systems incorporating standard building materials.

### BRIEF DESCRIPTION OF THE FIGURES

FIG. 1, Panels A and B are perspective views of a frame of the present invention illustrating a top front view in Panel A and a bottom rear view in Panel B.

FIG. 2 is a perspective view of a frame incorporating multiple transverse apertures to receive multiple boards.

FIG. 3 is a perspective top front view of a frame which employs a single vertical support aperture further providing an extended vertical dimension and employing an curved lower surface and reinforcing ribs.

FIG. 4 provides a perspective view of a frame incorporating structural reinforcing elements and two transverse apertures. As illustrated, the frame provides an extended lower portion defining an arch and reinforcing ribs.

FIG. 5 of the drawings provides a perspective view of one embodiment of the invention illustrating a frame in association with vertical supports wherein the frame further provides a transverse reinforcing aperture to receive a transverse reinforcing support.

FIG. 6 is an illustration of one embodiment of the frame wherein the frame provides interlocking dentations incorporated into the front and rear surfaces such that multiple frames may be linked by the vertical support.

FIG. 7 is an illustration of one embodiment of the frame wherein the frame provides interlocking dentations incorporated into the front and rear surfaces such that multiple frames may be linked by the vertical support, said dentated ends being rounded to facilitate angled elevated platform structures.

FIG. 8 is a perspective exploded view of one embodiment of a frame constructed from subassemblies wherein the subassembly comprising the upper surface of the frame when bonded to a lower subassembly form a completed frame.

FIG. 9 is a perspective exploded view of one embodiment of the construction of a frame employing a sandwich construction.

FIG. 10 is a perspective x-ray view of a frame incorporating an internal reinforcing member.

FIG. 11 is a perspective view of a detail of a reinforced frame having extended vertical dimensions relative to the body of the frame, said frame end incorporating a set screw frame locating means and reinforcing gussets.

FIG. 12 is an illustration of the use of pins as the frame locating means and a vertical support with regularly spaced holes to receive the pins.

FIG. 13 Panels A and B are perspective views of a detail of the end of a frame illustrating a top view in Panel A and a bottom view in Panel B wherein the frame is provided in a two pieced structure, the end of which forms a clamp. As illustrated in FIG. 13, the vertical support aperture is bisected vertically to define a frame subassembly incorporating a vertical semi-cylindrical recess to receive at least a portion of a cylindrical tubular vertical support and a saddle, said saddle also providing an opposing vertical semi-cylindrical recess to receive at least a portion of cylindrical tubular vertical support. As illustrated, the saddle is affixed to the frame subassembly by a plurality of threaded fasteners which when tightened apply a clamping force to the vertical support and the combined structure being a completed frame.

FIG. 14 is a perspective view illustrating the detail of a frame end, a vertical support and a two-piece collet. The lower portion of the vertical aperture of the frame is configured to have a frustoconical inner surface capable of receiving the frustoconically shaped outer surface of the collet such that when the collet is inserted into the frustoconical portion of the vertical support aperture, the two-piece collet is compressed against the vertical support.

FIG. 15 is a perspective x-ray view of the end of a frame illustrating one configuration of the vertical support aperture for use with a cylindrical vertical support, said vertical support aperture having an upper portion with a cylindrical inner surface and lower portion having a frustoconical inner surface. The lower portion of the vertical support aperture having a frustoconical inner surface is capable of closely receiving a two-piece collet having semi-frustoconical external surfaces and semi-cylindrical inner surfaces.

FIG. 16 is a perspective view of a frame end having extended vertical dimensions, the bottom surface of said frame end incorporating a threaded axial clamp with kerf extending downwardly from the bottom surface of the extended frame end coaxial with the vertical support aperture. Also illustrated is a threaded collar that is capable of engaging the threaded portion of the axial clamp. When tightened, the threaded collar compresses the axial clamp against a vertical support (not shown).

FIG. 17 Panels A and B provide upper and lower perspective views of a collet-clamp.

FIG. 18 is a perspective view of a frame, vertical supports, collet-clamps and threaded collars. The threaded collars are capable of engaging the threaded lower portion of the collet-clamp. When the threaded collars engage the threaded portion of the collet-clamp, the inner surface of the collet-clamp is compressed against the outer surface of the vertical support.

FIG. 19, provides an upper perspective view of an illustrative elevated platform system of the present invention comprising multiple frames, vertical supports, boards, and frame locating means.

FIG. 20 provides a perspective view of an illustrative elevated platform system of the present invention employing multiple frames, boards and support tubes, said frames incorporating interlocking dentations in ends of the frames, illustrating the ability of the frames of the present invention to create interlocking elevated platform systems capable of extending around corners.

### DETAILED DESCRIPTION OF THE INVENTION

Detailed embodiments of the present invention are disclosed herein. However, it is to be understood that the disclosed embodiments are merely illustrative of the invention that may be embodied in various forms. In addition, each of the examples given in connection with the various embodiments of the invention are intended to be illustrative, and not restrictive. Where a range of values is provided, it is understood that the upper and lower limits of the range and intervening values between the upper and lower limits of that range, as well as any subordinate ranges, are encompassed within the invention. As used herein, the singular forms “a”, “and”, and “the” shall be construed as including the plural unless the context clearly dictates otherwise. It will be apparent to those of skill in the art that the embodiments of the invention described herein may comprise discrete components that may be combined with components of other embodiments without departing from the scope of the present invention. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention. Furthermore, any section headings are merely for convenience of the reader and not intended to provide a limitation on the scope of the disclosure with respect to any feature of utility of the present invention.

The present invention provides a frame comprising at least one transverse aperture and at least one vertical support aperture said transverse aperture configured to closely receive at least one board. The present invention further provides a frame comprising at least one transverse aperture said transverse aperture configured to closely receive a board, at least one vertical support aperture, and a frame locating means. The present invention provides a frame, said frame comprising at least one transverse aperture and at least one vertical support aperture, said transverse aperture configured to closely receive at least one board. The invention further provides a frame wherein at least a portion of said vertical support aperture of said frame has a frustoconical inner surface. The invention further provides a frame comprising at least two vertical support apertures. The invention further provides a frame said comprising at least one transverse reinforcing aperture. The invention further provides a frame said frame incorporates one or more internal reinforcing structures. The invention further provides a frame comprised of two or more subassemblies.

The invention further provides an apparatus comprising a frame, said frame comprising at least one transverse aperture and at least one vertical support aperture, said transverse aperture configured to closely receive at least one board, and a frame locating means. The invention further provides an apparatus comprising a frame, said frame comprising at least one transverse aperture and at least one vertical support aperture, said transverse aperture configured to closely receive at least one board, and a frame locating means selected from the group consisting of one or more pins, set-screws, clamps, collets, split collets, axial clamps and collet clamps. The invention further provides an apparatus comprising a frame, said frame comprising at least one transverse aperture and at least one vertical support aperture, said transverse aperture configured to closely receive at least one board, wherein at least a portion of a vertical support aperture of said frame has a frustoconical inner surface and said frame locating means is selected from the group consisting of one or more collets, split collets, and collet clamps. The invention further provides an apparatus comprising a frame, said frame comprising at least one transverse aperture and at least one vertical support aperture, said transverse aperture configured to closely receive at least one board, wherein said frame is comprised of two or more subassemblies and wherein said frame locating means is one or more clamps. The invention further provides an apparatus comprising a frame, said frame comprising at least one transverse aperture and at least one vertical support aperture, said transverse aperture configured to closely receive at least one board, said apparatus further comprising a transverse reinforcing aperture.

The present invention further provides an apparatus for maintaining at least one board in a horizontal elevated position, said apparatus comprising:
a) a frame providing at least one transverse aperture to closely receive a board and at least one vertical support aperture;
b) at least one vertical support, and
c) at least one frame locating means.

The present invention further provides an elevated platform, said platform comprising:
a) a frame providing at least one transverse aperture to receive a board and at least one vertical support aperture;
b) at least one vertical support,
c) at least one frame locating means, and
d) at least one board.

The terms vertical, horizontal and depth are used in describing the present invention, in particular describing elevated platform systems constructed using frames and frame locating means of the present invention. The terms are used in reference to a base on which the elevated platform is typically situated. A base is typically a substantially fixed horizontal surface such as the floor of a building or the ground. As used herein, the term “horizontal” is the direction substantially parallel to the base in the direction of the long axis of the elevated platform. As used herein, the term “vertical” is used to refer to being a direction substantially perpendicular to the base. The term “depth” is used to describe the horizontal direction substantially perpendicular to the vertical and horizontal directions.

As used herein, the term “frame” refers to a structural member providing a top, bottom, left, right, front and back walls and at least one transverse aperture extending from the left wall to the right wall, said transverse aperture configured to closely receive at least one board, said frame further providing at least one vertical support aperture extending from the top wall to the bottom wall, said vertical support aperture configured to closely receive a vertical support.

As used herein, the term “closely receive” is used with respect to a frame and board to describe the difference in dimensions between the inner surface of the transverse aperture and the external surface of the board to be inserted through the aperture of the frame. Similarly, the term “closely receive” is used with respect to a vertical support and vertical support aperture to describe the difference in dimensions between the inner surface of the vertical support aperture and the external surface of the vertical support to be inserted through the vertical support aperture of the frame.

In general, the term “closely receive” describes the difference in dimensions of the transverse aperture and the board. A board is closely received when there exists a gap between the internal surface of the frame and the external surface of the board of less than or equal to 10 mm, less than or equal to 8 mm, less than or equal to 6 mm, less than or equal to 5 mm, less than or equal to 4 mm, less than or equal to 3 mm, less than or equal to 2 mm, less than or equal to 1 mm, less than or equal to 0.5 mm. In one embodiment, the frame closely receives a board when the inner dimensions of the aperture are approximately equal to the outer dimensions of the board to be inserted through the transverse aperture to provide slidable relationship between the board and the inner surface of the transverse aperture with essentially no gap between the board and the inner surface of the transverse aperture.

Similarly, with respect to the relationship between the internal surface of the vertical support aperture and the external surface of the vertical support, the vertical support is closely received when there exists a gap between the internal surface of the frame and the external surface of the vertical support of less than or equal to 10 mm, less than or equal to 8 mm, less than or equal to 6 mm, less than or equal to 5 mm, less than or equal to 4 mm, less than or equal to 3 mm, less than or equal to 2 mm, less than or equal to 1 mm, less than or equal to 0.5 mm. In one embodiment, the frame closely receives a vertical support when the inner dimensions of the vertical support aperture are approximately equal to the outer dimensions of the vertical support to be inserted through the vertical support aperture to provide slidable relationship between the vertical support and the inner surface of the vertical support aperture with essentially no gap between the vertical support and the walls of the vertical support aperture. In one embodiment, the vertical support is closely fitting with respect to only a portion of the inner surface of the vertical support aperture.

The term “board” is used in its conventional sense to describe a length of stiff material. Examples of “stiff materials” which may comprise a board include but are not limited to solid or hollow rectangular structures of wood, plastic, and/or metal. Further examples of stiff materials may be constructed from composite materials such as plastic wood, particle board, chipboard, and fiber-reinforced composite, or wood-plastic composite. In one embodiment, the term board refers to dimensional lumber. Dimensional lumber refers to wood building materials provided in standard sizes well known to those of skill in the art. Dimensional lumber may be produced in accordance with a variety of standards. North American softwood and hardwood dimensional lumber standards are provided in Tables 1 and 2, respectively, below.

TABLE 1
North American Softwood Dimensional Lumber Sizes

| Nominal | | |
|---|---|---|
| Dimensions | Actual Dimensions | |
| 1 × 2 | ¾″ × 1½″ | (19 mm × 38 mm) |
| 1 × 3 | ¾″ × 2½″ | (19 mm × 64 mm) |
| 1 × 4 | ¾″ × 3½″ | (19 mm × 89 mm) |
| 1 × 6 | ¾″ × 5½″ | (19 mm × 140 mm) |
| 1 × 8 | ¾″ × 7½″ | (19 mm × 184 mm) |
| 1 × 10 | ¾″ × 9½″ | (19 mm × 235 mm) |
| 1 × 12 | ¾″ × 11½″ | (19 mm × 286 mm) |
| 2 × 2 | 1½″ × 1½″ | (38 mm × 38 mm) |
| 2 × 3 | 1½″ × 2½″ | (38 mm × 64 mm) |
| 2 × 4 | 1½″ × 3½″ | (38 mm × 89 mm) |
| 2 × 6 | 1½″ × 5½″ | (38 mm × 140 mm) |
| 2 × 8 | 1½″ × 7½″ | (38 mm × 184 mm) |
| 2 × 10 | 1½″ × 9½″ | (38 mm × 235 mm) |
| 2 × 12 | 1½″ × 11½″ | (38 mm × 286 mm) |
| 4 × 4 | 3½″ × 3½″ | (89 mm × 89 mm) |
| 4 × 6 | 3½″ × 5½″ | (89 mm × 140 mm) |
| 6 × 6 | 5½″ × 5½″ | (140 mm × 140 mm) |
| 8 × 8 | 7¼″ × 7¼″ | (184 mm × 184 mm) |

TABLE 2
North American Hardwood Dimensional Lumber Sizes

| Nominal | S1S | | S2S | |
|---|---|---|---|---|
| (rough-sawn size) | (surfaced on one side) | | (surfaced on two sides) | |
| ½ in | ⅜ in | (9.5 mm) | 5/16 in | (7.9 mm) |
| ⅝ in | ½ in | (13 mm) | 7/16 in | (11 mm) |
| ¾ in | ⅝ in | (16 mm) | 9/16 in | (14 mm) |
| 1 in or 4/4 in | ⅞ in | (22 mm) | 13/16 in | (21 mm) |
| 1¼ in or 5/4 in | 1⅛ in | (29 mm) | 1 1/16 in | (27 mm) |
| 1½ in or 6/4 in | 1⅜ in | (35 mm) | 1 5/16 in | (33 mm) |
| 2 in or 8/4 in | 1 13/16 in | (46 mm) | 1¾ in | (44 mm) |
| 3 in or 12/4 in | 2 13/16 in | (71 mm) | 2¾ in | (70 mm) |
| 4 in or 16/4 in | 3 13/16 in | (97 mm) | 3¾ in | (95 mm) |

The frame provides at least one vertical support aperture extending from the top wall to the bottom wall, said vertical support aperture configured to receive a vertical support. A vertical support aperture is generally provided to closely receive a vertical support. The frame may provide multiple vertical support apertures. The frame may provide one, two, three, four, five or more vertical support apertures.

The frame may further incorporate features to improve structural strength and resistance to deformation. Examples of such structural features include but are not limited to arched structures, ribs or bosses.

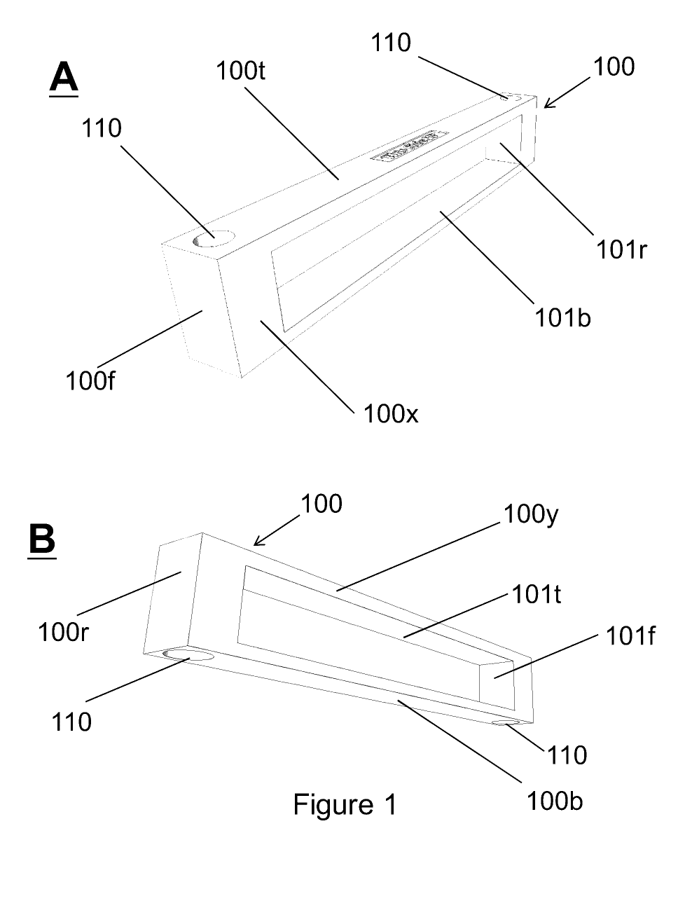

One embodiment of a frame of the invention is illustrated in FIG. 1 of the attached drawings. FIG. 1, Panels A and B provide upper front and lower rear perspective views of a frame (100) having a top wall (100t), a bottom wall (100b), a front wall (100f), rear wall (100r), right wall (100x) and left wall (100y), a transverse aperture (101) defined by a top wall (101t), bottom wall (101b), front wall (101f) and rear wall (101r) and two vertical support apertures (110) to receive two vertical supports (not shown).

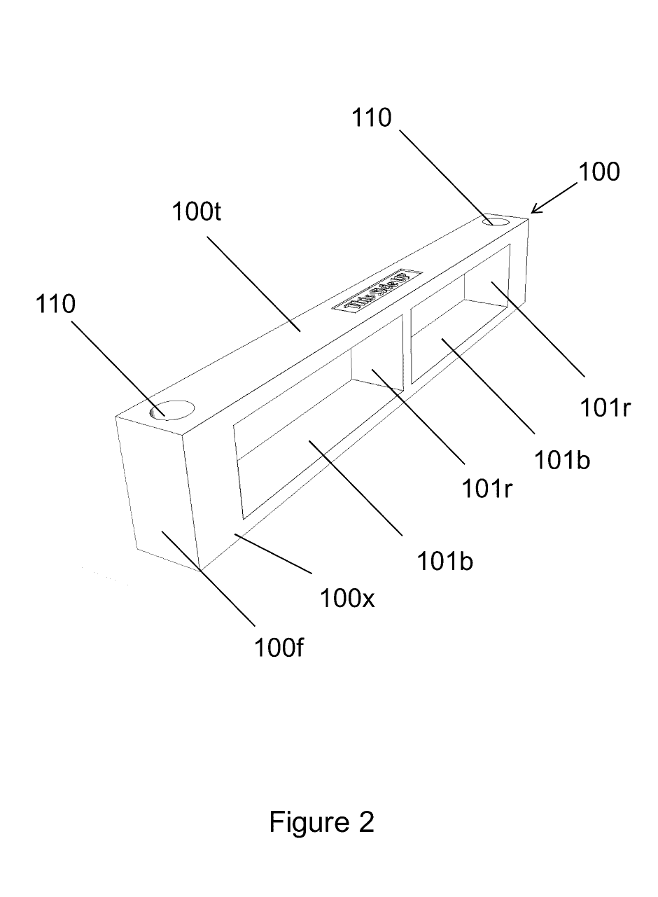

Another embodiment of a frame of the present invention is illustrated in FIG. 2 of the attached drawings. FIG. 2 provides a perspective view of a frame (100) having a top wall (100t), a bottom wall (100b), a front wall (100f), rear wall (100r), right wall (100x) and left wall (100y), and two transverse apertures (101), each transverse aperture defined by an top wall (not shown), bottom wall (101b), front wall (not shown) and rear wall (101r) and two vertical support apertures (110) to receive two vertical supports (not shown).

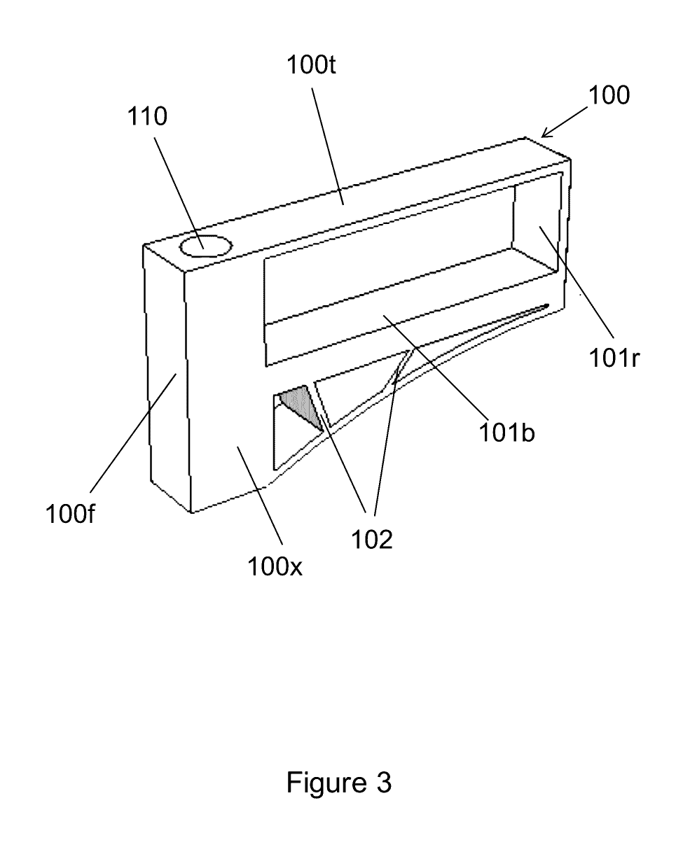

Another embodiment of a frame of the present invention is illustrated in FIG. 3 of the attached drawings. FIG. 3 provides a perspective view of a frame (100) having a top wall (100t), a bottom wall (not shown), a front wall (100f), a rear wall (not shown), a right wall (100x) and a left wall (not shown), and a transverse aperture (101) defined by a top wall (not shown), a bottom wall (101b), a front wall (not shown) and a rear wall (101r) and a vertical support aperture (110) to receive a vertical support (not shown). As illustrated, the bottom wall of the frame defines an arch with multiple reinforcing ribs (102) to provide additional structural reinforcement and resist deformation from vertical loading.

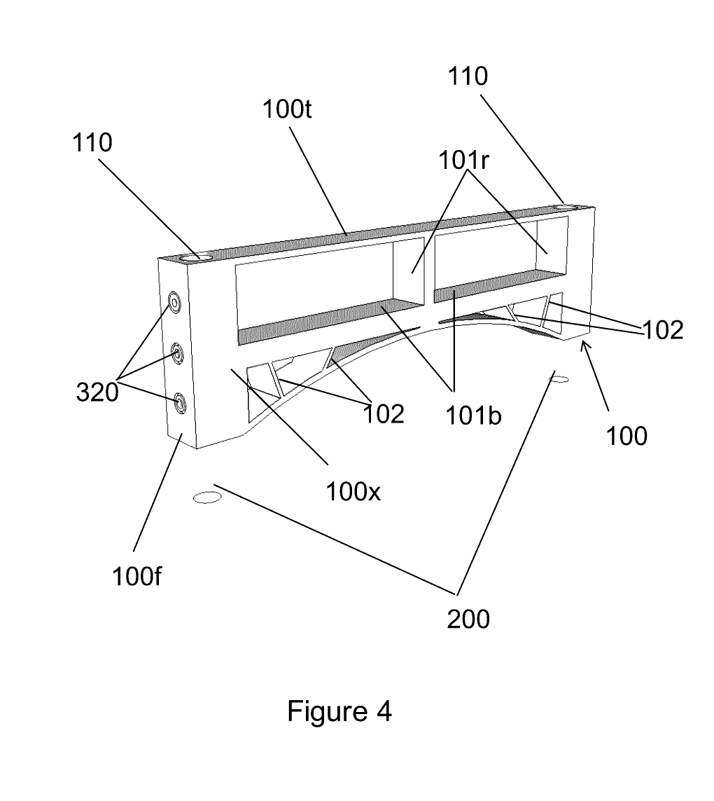

Another embodiment of a frame of the present invention is provided in FIG. 4 of the attached drawings. FIG. 4 provides a perspective view of a frame (100) having a top wall (100t), a bottom wall (100b), a front wall (100f), rear wall (100r), right wall (100x) and left wall (100y), a transverse aperture (101) defined by a top wall (101t), bottom wall (101b), front wall (101f) and rear wall (101r) and two vertical support apertures (110) to receive two vertical supports (200), the lower portion of the frame (100) incorporating an arched structure with multiple reinforcing ribs (102). Also illustrated in FIG. 4 is a frame locating means comprising multiple set screws (320) which are inserted through threaded apertures (not shown) extending through the frame from the front and rear walls and pierce the inner wall of the vertical support aperture (not illustrated) and engage the vertical support (200).

The frame may also provide one or more transverse reinforcing apertures, said transverse reinforcing apertures extending from the right wall to the left wall to closely receive one or more transverse reinforcing members. Transverse reinforcing members are generally elongated structural members that are positioned horizontally in the direction of the long axis of the boards. The transverse reinforcing members(s) can be of any particular cross section (e.g. square, round, oval) and can be solid or hollow. As previously noted, the transverse reinforcing aperture of the frame is designed to closely receive the transverse reinforcing members so that the choice of transverse reinforcing members design should facilitate a close-fitting relationship between the transverse reinforcing members and transverse reinforcing aperture of the frame. In one embodiment of the invention, the transverse reinforcing member is a cylindrical hollow tube. A transverse reinforcing member and such transverse reinforcing member is generally constructed of a high strength material such as steel, aluminum alloy, or steel alloy. In alternative embodiments, the frame may provide two, three or more transverse reinforcing apertures. The frame may optionally provide a transverse reinforcing member locating means (e.g., pin, set screw) to resist movement of the transverse reinforcing member relative to the frame.

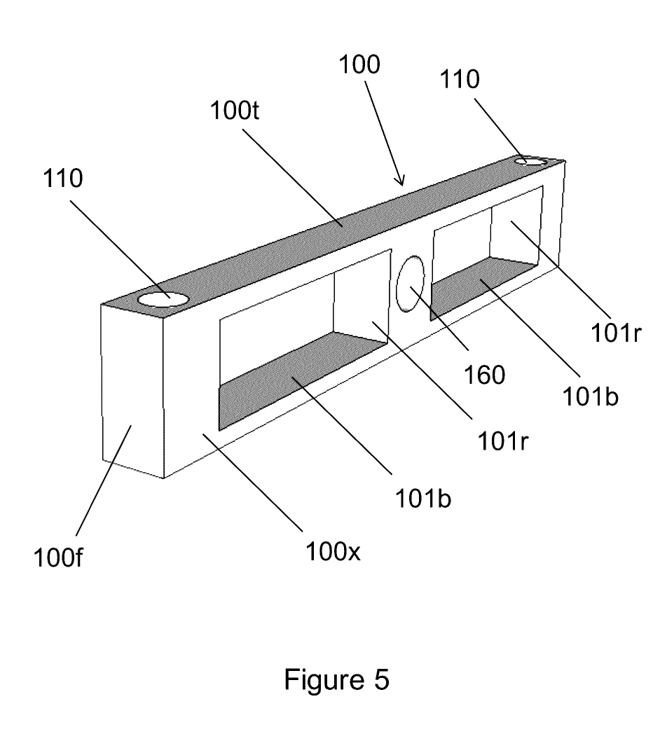

An illustrative embodiment of a frame of the present invention providing a transverse aperture and transverse reinforcing member is provided in FIG. 5 of the attached drawings. FIG. 5 provides a perspective view of a frame (100) having a top wall (100t), a bottom wall (100b), a front wall (1000, rear wall (100r), right wall (100x) and left wall (100y), two transverse apertures (101) each defined by a top wall (not shown), bottom wall (101b), front wall (not shown) and rear wall (101r), two vertical support apertures (110) to receive two vertical supports (not shown) and a transverse reinforcing aperture (160).

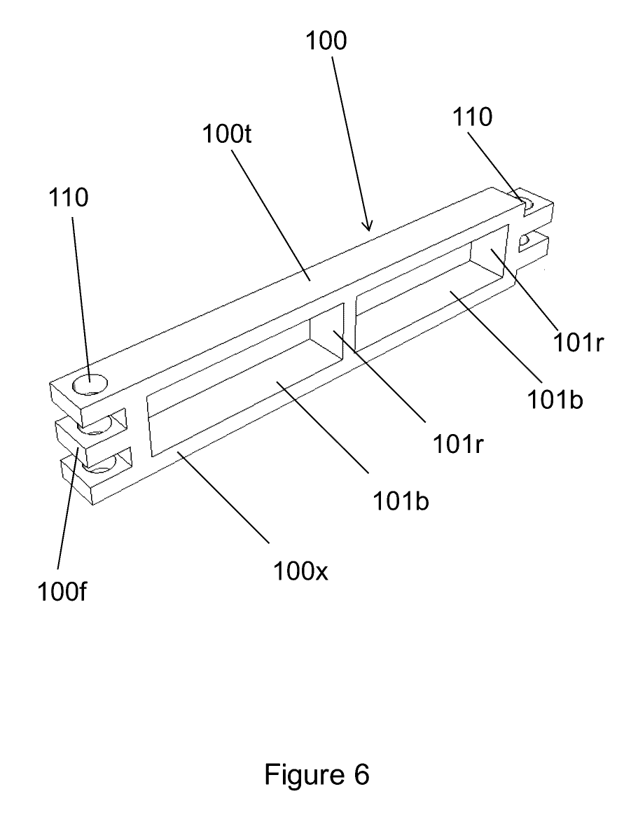

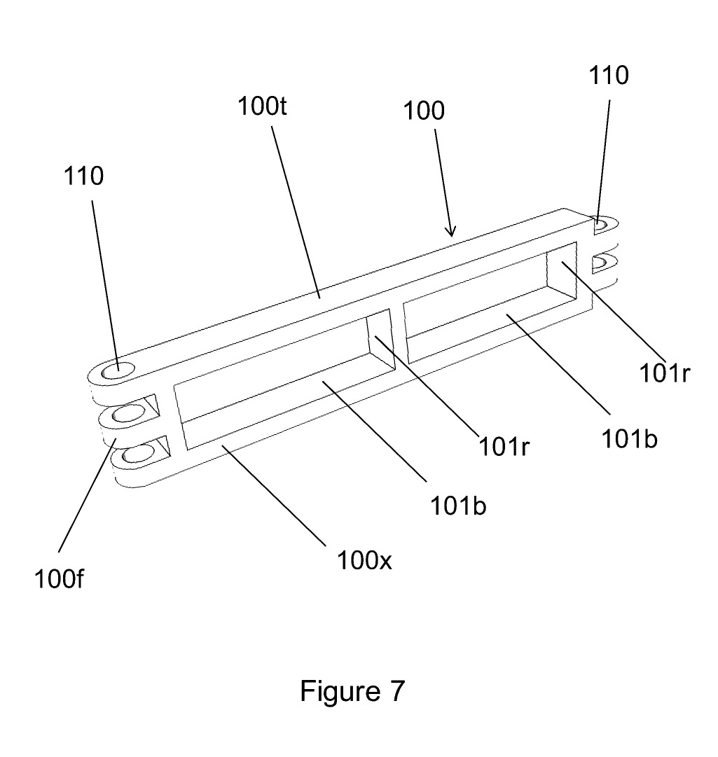

The frame may also provide for interlocking features incorporated into the ends of the frame members to enable front to back interlocking of multiple frames. One embodiment of a frame incorporating such interlocking means is illustrated in FIGS. 6 and 7 of the attached drawings. As illustrated in FIG. 6, the front wall (1000 and rear wall (100r) of the frame incorporate recesses to create corresponding dentations which intercalate enabling linkage of multiple frames, the vertical support providing interlocking of the frames. The use of interlocking features on the end faces of the frame enable the frames to adapt to a variety of situations by enabling horizontal surfaces (e.g., shelves) of varying depths. As illustrated in FIG. 7, the front wall of the frame (100f) is curved to enable the interlocked frames to be rotated relative to each other.

The frame may also provide for apertures to permit the passage of fasteners that insert into the boards to retard movement of the board with respect to the transverse aperture of the frame. For example, the wall of the transverse aperture may provide one or more holes to permit the passage of a screw(s) such that, once the board(s) are properly located, the screw passes through the vertical hole in the frame and is screwed into the board such that the transverse movement of the board relative to the frame is retarded.

The skilled artisan will appreciate that the horizontal, vertical and transverse dimensions of the frame and associated components of the apparatus may be varied to according to the particular application. For example, the choice of materials and the dimensions of the frame and other components of the apparatus are variable depending on factors such as anticipated vertical, horizontal and torsional forces, board dimensions, nature of the frame locating means, the use of transverse supports, transverse support aperture(s), the horizontal distance between the vertical supports, the spacing between boards, load to be supported and board thickness and/or frame materials may be optimized for particular applications in accordance with conventional engineering principles understood by those of ordinary skill in the art. The principles guiding such design variables are well known to those of skill in the art and may be tailored to particular circumstances by applying basic mechanical engineering principles and are described in standard texts and handbooks in the field (see e.g Marks' Standard Handbook for Mechanical Engineers, 8^{th} Edition, (1978) Baumeister, et al., editors, McGraw Hill Publishing, New York). Additional factors such as compliance with building or safety codes and/or resistance to environmental factors such as earthquakes are additional factors for consideration by the skilled artisan in optimizing the frame dimensions in a particular application. In general, frame materials are selected to resist deformation by shear, impact and load forces. In general, materials are chosen which have a higher Young's modulus and lower Poisson Ratio.

The apparatus of the present invention may be constructed of any of a variety of materials. Examples of materials suitable for use in construction of the housing and supports include but are not limited to plastics, reinforced (composite) plastics, metals, wood, compressed paper, glass, rigid foams, cardboard, glass and/or ceramics. The frame and other components of the apparatus may be constructed from the same materials or may be produced from different materials. Materials useful for the construction of the frame, and metals. Examples of plastic materials useful in the construction of the frame are well known in the art and the techniques involved in forming frames of the materials will be apparent to the skilled artisan. The term plastics includes but is not limited to polycarbonate (PC), polyethylene (PE), high density polyethylene (HDPE), polyetherimide (PEI), polysulfone (PSO), polyethersulfone (PES), polyethylene terepthalate (PET), polypropylene, polystyrene, high impact polystyrene (HIPS), acrylanitrile butadiene styrene (ABS), polyvinylchloride (PVC), acetal, Nylons (e.g., Nylon 4-6, Nylone 6-6, Nylon 11, or Nylon 12), acrylic-styrene-acetonitrile (ASA), polyester liquid crystal polymer (LCP), stylene acrylonitrile (SAN), polyvinyldiene difluoride (PVDF), melamine, phenolics and the like. Examples of composite materials useful in construction of the frame include but are not limited to metal reinforced plastics, glass reinforced plastics or carbon fiber reinforced plastics (e.g. Minlon® DuPont). Such composite materials may be formed using conventional molding technologies, hand lay-up or spray lay-up technologies. Frames constructed of plastic materials may be constructed using conventional molding and/or machining techniques including but not limited to compression molding, injection molding, blow molding, casting, extrusion, pressure forming, and deposition forming (“3-D printing”).

Examples of metals useful in the construction of the frame include but are not limited to steel and steel alloys (e.g. stainless steel), aluminum and aluminum alloys, and magnesium and magnesium alloys. Metals may be formed using conventional techniques such as stamping, casting, machining, forging (including powder forging), hydroforming, thermoforming, deposition forming (“3-D printing”), and compression molding.

In some instances, it may be desirable to provide a finish to the materials employed for the frame and other components of the apparatus to minimize corrosion from atmospheric or operator sources or to improve durability, handing characteristics or appearance. Optionally, the materials may be electroplated, painted, dip-coated, or flocked to enhance appearance and/or durability.

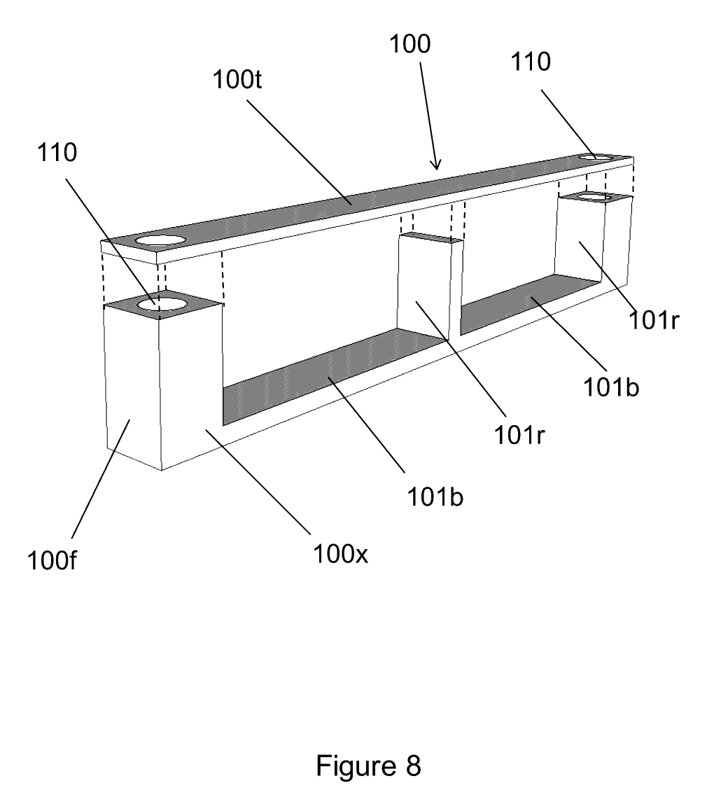

The frame may be of monolithic construction (e.g. composed of a single unit) or composed of subassemblies that are bonded together. For example, as illustrated in FIG. 8 of the attached drawings, a two-piece frame providing a lower frame subassembly defining the front wall (not shown), back and bottom sides of the transverse apertures, the bottom the frame and a portion of the front and rear walls of the frame, and a portion of the vertical support apertures is joined to a second upper frame subassembly which, when bonded to the lower frame subassembly, becomes the top surface of the frame, the upper walls of the transverse apertures, and completes the front and rear walls of the frame

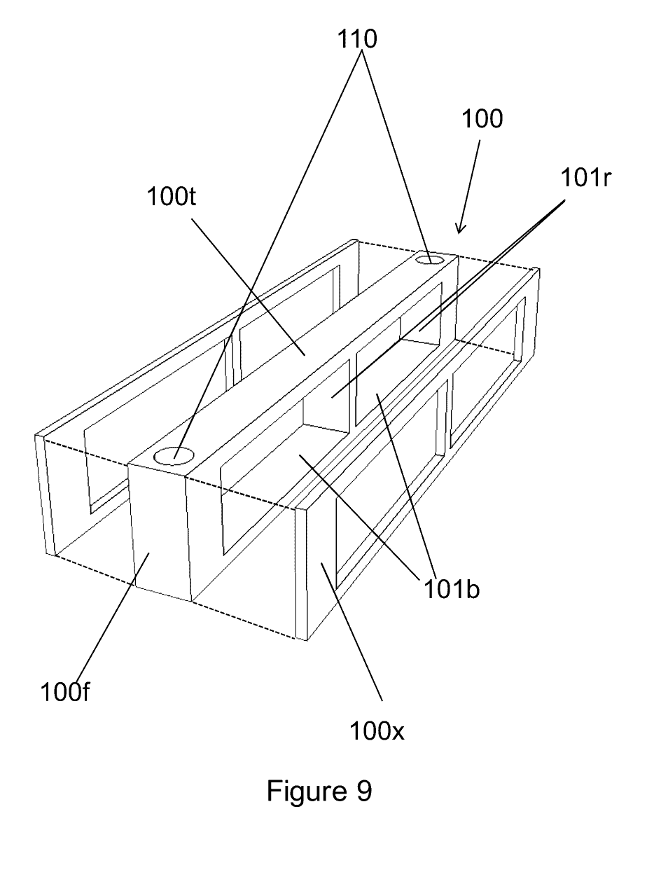

Additionally, a frame may be reinforced by the addition of surfaces having a greater structural strength resulting in a sandwich construction. One embodiment of such a sandwich frame construction is illustrated in FIG. 9.

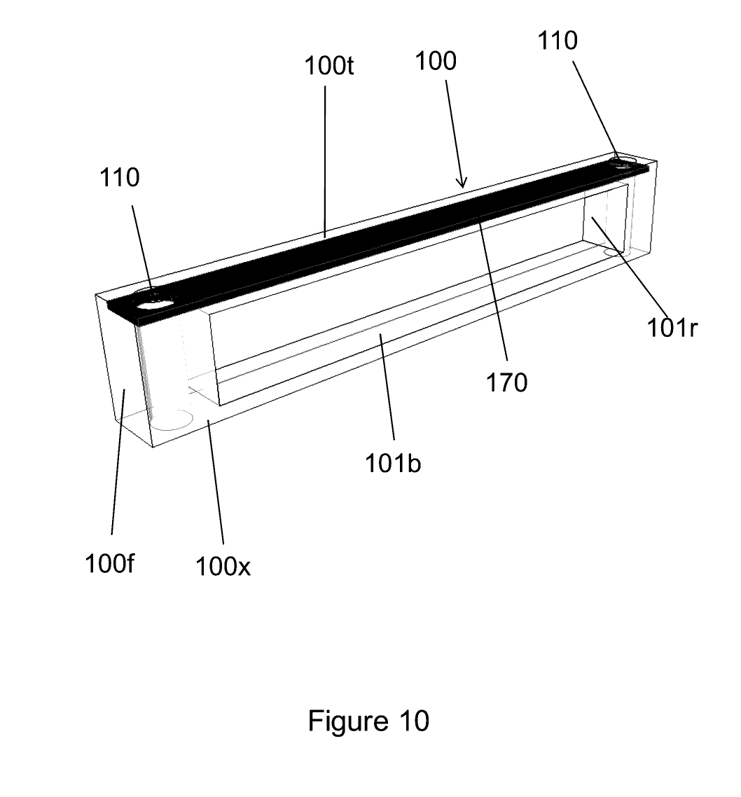

In another embodiment of the invention, the frame may incorporate an internal reinforcing structure. For example, a plastic frame may incorporate a metal reinforcing element. An illustrative example of a frame incorporating an internal reinforcing structure is provided in FIG. 10 of the attached drawings. FIG. 10 provides an x-ray view of a frame incorporating an internal reinforcing structure (170) of the frame that provides apertures corresponding to the placement of the vertical support apertures (110) to permit passage of the vertical supports (not shown).

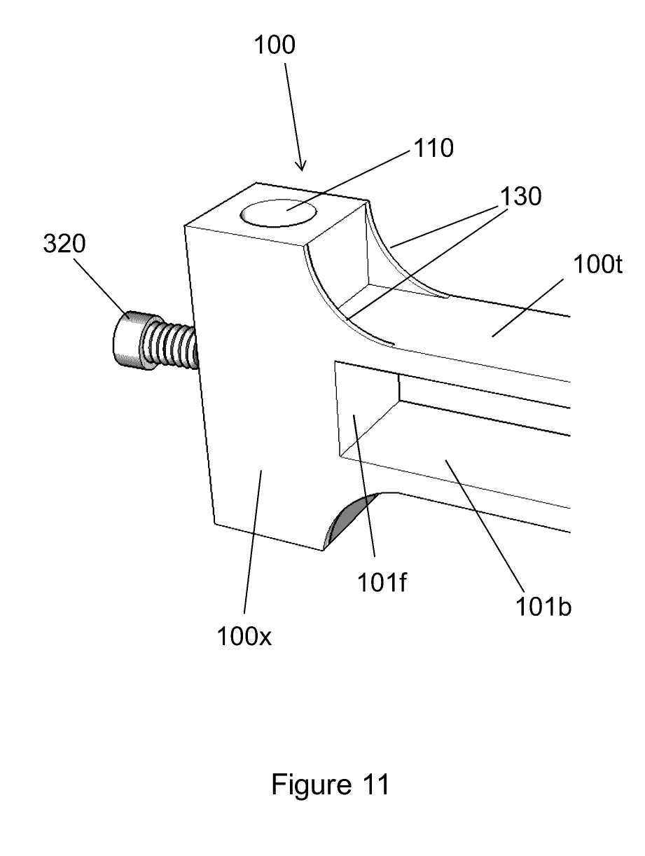

The frame may also incorporate end structures of extended vertical dimensions to facilitate greater interaction with the vertical support(s), such a configuration providing greater resistance to shear forces. An illustration of a frame incorporating an end with extended vertical dimension is provided in FIG. 11 of the attached drawings. As illustrated in FIG. 11, a portion of the top wall of the frame (100t) and a portion of the bottom wall of the frame (not shown) encompassing the vertical support aperture (110) are displaced vertically relative to the long axis of the frame, the extended portion being reinforced with gussets (130) to provide additional support. In such configuration, the front wall of the frame is extended from the displaced upper wall to the displaced lower wall.

The apparatus of the present invention employs one or more vertical supports. A vertical support is generally provided as an elongated structural member that is positioned vertically relative to a support surface. The vertical support(s) can be of any particular cross section (e.g. square, round, oval) and can be solid or hollow. As previously noted, the vertical support aperture of the frame is designed to closely receive the vertical support so that the choice of vertical support design should facilitate a close-fitting relationship between the vertical support and the vertical support aperture of the frame. In one embodiment of the invention, the vertical support is a cylindrical hollow tube.

As previously noted with respect to the frame, the particular dimensions and nature of the vertical supports will be readily adapted to various applications by one of ordinary skill in the art.

The vertical supports may be constructed of any of a variety of rigid materials that are well known to those of skill in the art including but not limited to wood, plastics, reinforced (composite) plastics, and metals. Examples of metals useful in the construction of vertical supports include, steel, aluminum, magnesium, and alloys thereof (e.g. stainless steel, CrMo steel, 6061 aluminum alloy).

The lower extent of a vertical support may incorporate an adjustable “foot” element to adapt to uneven bases. In one embodiment, such an adjustable foot structure is provided by an insert that is designed for axial insertion into the central void of a tubular vertical support, the insert providing a means to prevent sliding through the length of the tubular vertical support (e.g. press fit, machined shoulder structure), said insert providing a threaded aperture to receive a threaded fastener (e.g. a hex bolt) so that when the vertical support is placed on the base, turning of the threaded fastener results in vertical displacement of the vertical support member.

The surface of the vertical support can be untreated bare material. Alternatively, the surface of the vertical support may be coated to enhance durability and resist corrosion with any of a variety of durable coatings well known to those of skill in the art. The external surface of the vertical support may be coated to enhance grip between the vertical support and the vertical locating means. For example, the surface of the vertical support may be treated to enhance friction between the vertical support and the locating means. Examples of such treatments include roughening of the surface, incorporating ridges, knurling, or applying anti-slip coatings comprised of elastomeric materials.

In one embodiment of the invention, the vertical supports are constructed of conventional smooth surfaced tubing. Use of such smooth surface tubing obviates the needs for specifically constructed vertical supports having annular grooves and therefore reduces costs and provides for increased structural strength for a vertical support of a given outside diameter as tubing without annular grooves is stronger as the annular grooves provide stress risers and weak points.

The term “frame locating means” is used to describe any of a variety of means to provide positive location of the frame relative to a vertical support and restricts the motion of the frame relative to the vertical support. The frame locating means may be incorporated into the structure of the frame or may be provided separate from the frame. The frame locating means may incorporate elements that bite into the vertical supports, rely on vertical supports with structural features to enhance interaction with the frame locating means, or may comprise other elements that create high static friction between the frame locating means and the vertical support.

In one embodiment, the frame locating means is collar. A collar is a sleeve that slides over the outside of the vertical support. In one embodiment, the collar is retained by a by a set screw through the wall of the collar and, when tightened, contacts the vertical support and retains the collar in position on the vertical support. The frame then rests on the upper surface of the collar. The set screw may be designed for tightening by conventional tools such screwdrivers, Allen keys, wrenches, or tool-free tightening such as a knob screw or thumb screw. Alternatively, the collar may be a clamping collar that is compressed against the vertical support. In some instances, two collars, one located above and one below the frame on the vertical support, may be employed which results in positive vertical location of the frame relative to the vertical support and resists upward dislocation of the frame.

Alternatively, the vertical location of the frame relative to the vertical support may be achieved by the use of threaded set screws that thread through a threaded aperture provided in the frame from the outer surface of the frame into the vertical support receiving aperture. The set screw frame locating means provides positive location of the frame relative to the vertical support resisting both upward and downward motion of the frame relative to the vertical support. When the frame is constructed of materials that are not prone to wear by repeated insertion of threaded fasteners (e.g. metals), the threaded aperture may be provided in the frame itself to maximize reuse of the frames. When the frame is constructed of materials that are prone to wear by repeated insertion of threaded fasteners (e.g. plastics) a threaded metal insert may be used to minimize wear through repeated tightening of the set screw. The set screw may be designed for tightening by conventional tools such screwdrivers, Allen keys, wrenches, or tool-free tightening by the use of a knob screw or thumb screw.

In an alternative embodiment, the frame locating means are pins that are received by corresponding holes provided in a vertical support. In one embodiment, the frame rests on the pin. In another embodiment, a pin is employed which passes through apertures in the wall of the frame and passes through corresponding opposed holes in the vertical support. Such pin goes through horizontally corresponding opposing apertures provided in the frame and the vertical support. The pin may be a simple clevis pin, optionally providing a retaining means such as a spring pin or cotter pin or a threaded fastener that is secured by a nut or a threaded aperture in the frame. When pins are used for as the frame locating means, the vertical support members are generally provided with regularly spaced holes. Alternatively, the vertical support members may be modified by drilling transverse opposing holes through the vertical support to receive the pin at the desired location.

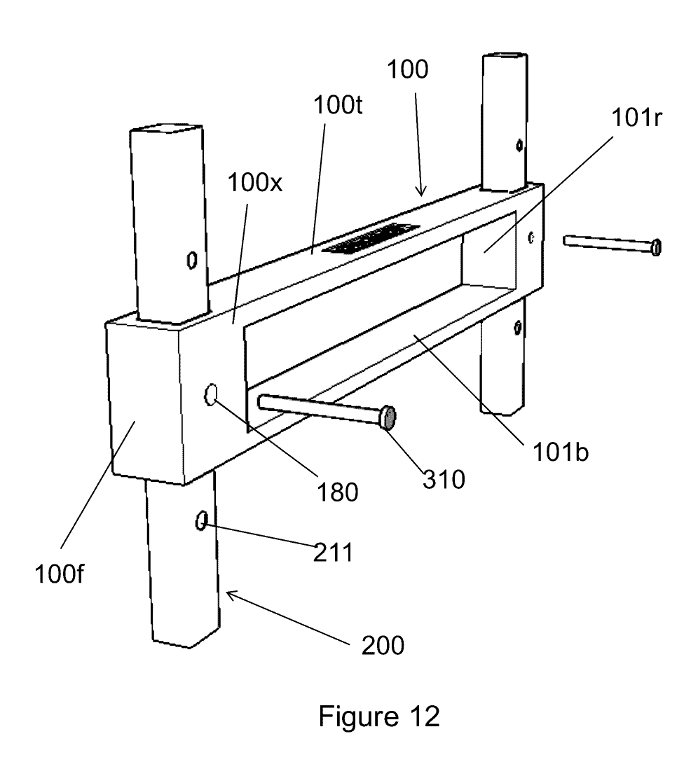

One embodiment of the invention incorporating pins as a frame locating means is provided in FIG. 12 of the attached drawings. FIG. 12 provides a perspective view of a frame (100) providing vertical support apertures (not shown) to receive two vertical supports (200) and providing a transverse hole (180) to receive a pin (310) that passes through the transverse hole (180), through the corresponding hole in the vertical support (211)

In an alternative embodiment, positive retention of the frame locating means is achieved by clamping the frame locating means against the vertical support resulting in high static friction between the frame locating means and the vertical support. An example of such a clamping means include compressive collars such as spring wire clamps may be employed. A wide variety of spring wire clamps are commercially available from Emwards Fastening Ltd, Beaumont Close, Banbury, Oxon OX16 1TG UK. Clamping collars may also be so employed.

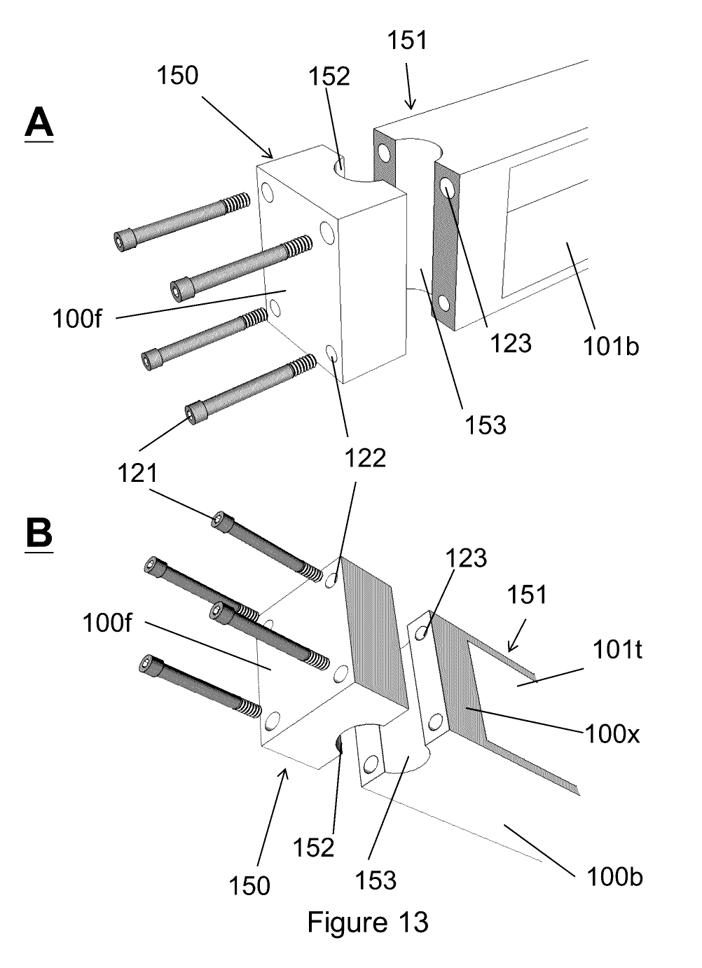

In an alternative embodiment, the frame locating means may be achieved by incorporating a clamp into the frame. One embodiment of such a frame which incorporates a clamp is illustrated in FIG. 13, Panels A and B. Referring to FIG. 13, a kerf bisects the vertical support aperture of the frame creating a saddle (150) and frame subassembly (151), the saddle (150) and frame subassembly (151) each providing an opposing semi-cylindrical recess (152, 153 respectively) such that when the saddle (150) is attached to the frame subassembly (151), the semi-cylindrical frame recesses (152 and 153) define a substantially cylindrical vertical support aperture. As illustrated in FIG. 13, the saddle (150) is affixed to the frame using threaded fasteners (121) that pass through fastener apertures (122) of the saddle (150) and are received by corresponding threaded recesses (123) of the frame subassembly (151). Alternative to the use of threaded fasteners, the saddle may incorporate a quick-release (over-center mechanism) for easy assembly and shelf adjustment. Inner surfaces of the semi-cylindrical recess (152, 153) may provide further anti-friction coatings that enhance the static friction of the frame relative to the vertical support. Examples of such materials include any of a variety of deformable materials including but not limited to rubbers (natural, synthetic, neoprene rubbers) or soft plastics.

In an alternative embodiment, a collet may be employed. A collet is a sleeve with a cylindrical inner surface and a frustoconical outer surface. A collet may be one piece or comprised of multiple pieces. In one embodiment, the collet consists of two portions, each portion defining a semi-cylindrical inner surface having a radius substantially identical to the exterior radius of the vertical support. Such collet provides a slight gap between each portion facilitating compression against the vertical support. In an alternative embodiment, the collet may be constructed of deformable materials that are deformed inwardly in response to the application of the radial force exerted against the outer surface of the collet by the inner walls of the frustoconical recess of the frame. The use of deformable materials for construction of the collet may provide enhanced static friction between the collet and vertical support such as through the use of ridges, elastomeric materials, and the like.

The collet is typically received into a recess provided in the frame, said recess having a frustoconical inner surface, such frustoconical recess being incorporated into the lower portion of the vertical support aperture. The frustoconicial outer surface of the collet mates to the inner surface of the frustoconical recess of the frame. When a vertical load is applied to the frame, the interaction compresses the inner cylindrical surface of the collet against the vertical support creating high static friction between the collet and the vertical support. The inner cylindrical surface of the collet in contact with the vertical support may optionally be coated with friction enhancing materials that further enhance the static friction between the collet and the vertical support. Examples of such materials include any of a variety of deformable elastomeric materials including but not limited to organic (rubbers) or inorganic (e.g. silicone) elastomers.

The frame locating means may also be collets that provide at least one internal annular ridge that is capable of interaction with a vertical support provided with corresponding annular grooves to receive the inner annular ridges of the collet. Such collet and vertical support tubes are known in the art and are commercially available from a variety of suppliers.

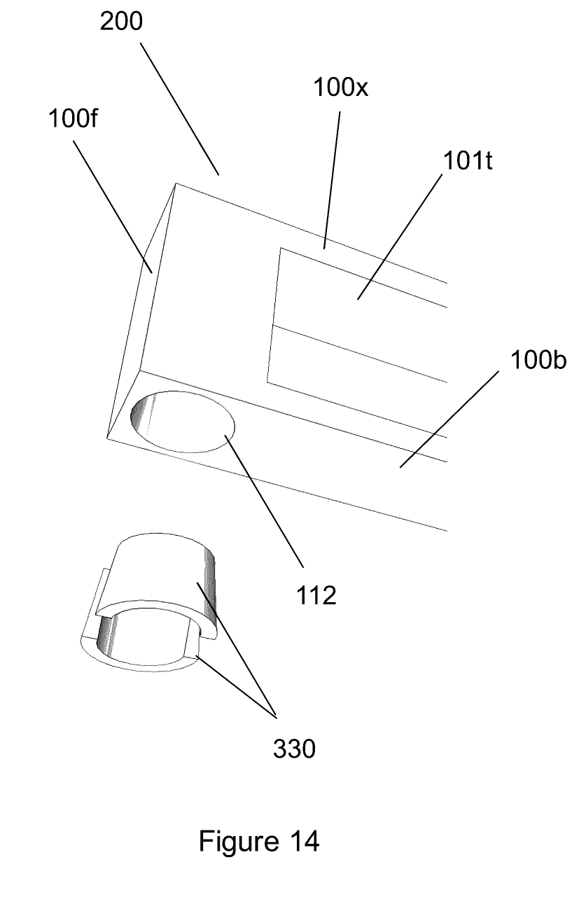

One embodiment of the use of collets as frame locating means is illustrated in FIG. 14 of the attached drawings. FIG. 14 provides a perspective view of the underside of the frame (100) illustrating the frustoconical recess (112), a split collet comprised of two collet portions (330), and a vertical support.

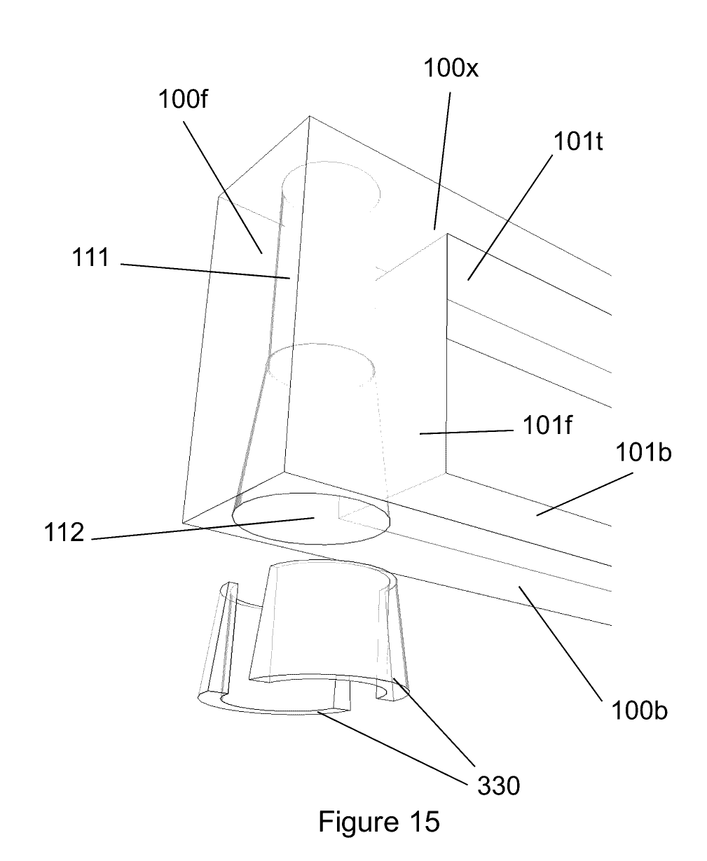

FIG. 15 provides a detailed x-ray view of the end of a frame for use with a collet frame locating means illustrating the configuration of the vertical support aperture for use with a tubular vertical support. In reference to FIG. 15, the vertical support aperture is comprised of an upper portion (111) having a substantially cylindrical inner face and a lower portion (112) having a frustoconical inner face which defines the recess which receives the frustoconically-shaped collet.

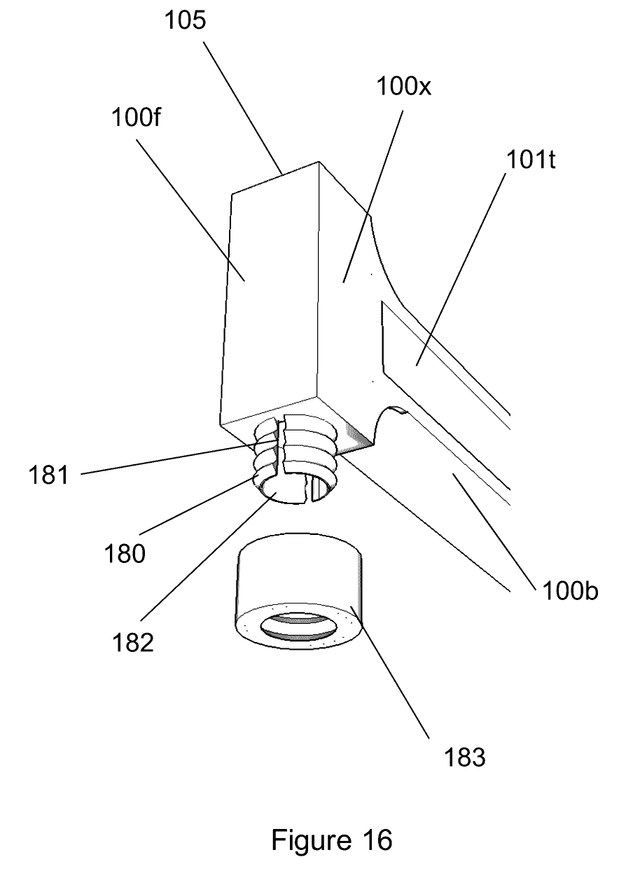

In an alternative embodiment, the frame locating means may be achieved by use of an axial clamp. One embodiment of an axial clamp as a frame locating means for use with a tubular vertical support is illustrated in FIG. 16 of the attached drawings. Referring to FIG. 16, the frame provides a threaded lower extension (180), said threaded extension providing one or more kerfs (181) to facilitate compression and a threaded collar (183) that engages the threads of the extension (180) and when tightened applies compressive force the extension compressing the semi-cylindrical inner surface (182) against a cylindrical tubular vertical support (not shown). The threaded portion of the extension may be provided with tapered threads to facilitate compression against the vertical support as the threaded collar is tightened. The external surface of the collar may provide flat surfaces to facilitate wrench tightening or knurled or grooved surfaces to facilitate tool-free hand tightening.

The invention further provides a combination collet and clamp (“collet-clamp”) as a frame locating means. The collet-clamp is particularly useful when the vertical supports are smooth tubing as the frame locating means resists movement along the vertical support from both the clamping force provided by the clamp mechanism as well as the compressive force of the collet when the collet portion of the collet-clamp is received into the frustoconical recess of the frame. The clamp portion of the collet-clamp may employ any of a variety of means to apply an inward radial clamping force such as axial clamps, toggle clamps, hook-lock clamps, band clamps, hose clamps, spring clamps and the like.

The collet-clamp may be formed of a single piece or multiple pieces. In general, to for ease of use, it is desirable to have the frame locating means be installable over the surface of the vertical support rather than having it be slid over the length of the vertical support. Consequently, the collet-clamp may be constructed of a deformable material with a single axial cut to permit installation over the vertical support. Alternatively, the collet-clamp may be formed of semi-cylindrical structures that are hingedly attached and a clamping means provided at the opposite side (e.g. a hinged split clamp). Such a hinge may be a conventional hinge or a living hinge.

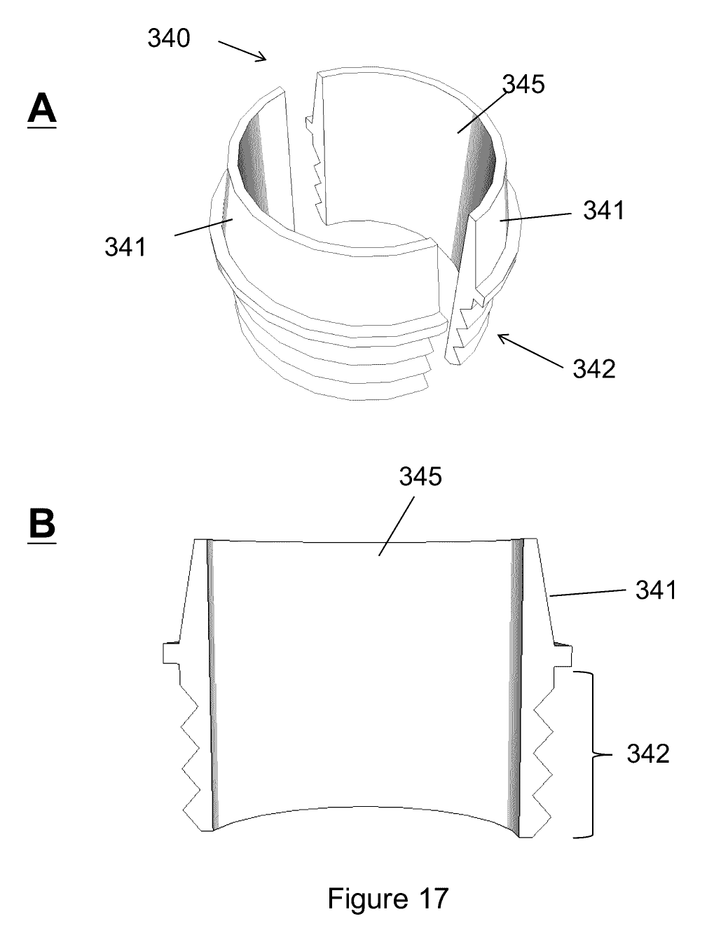

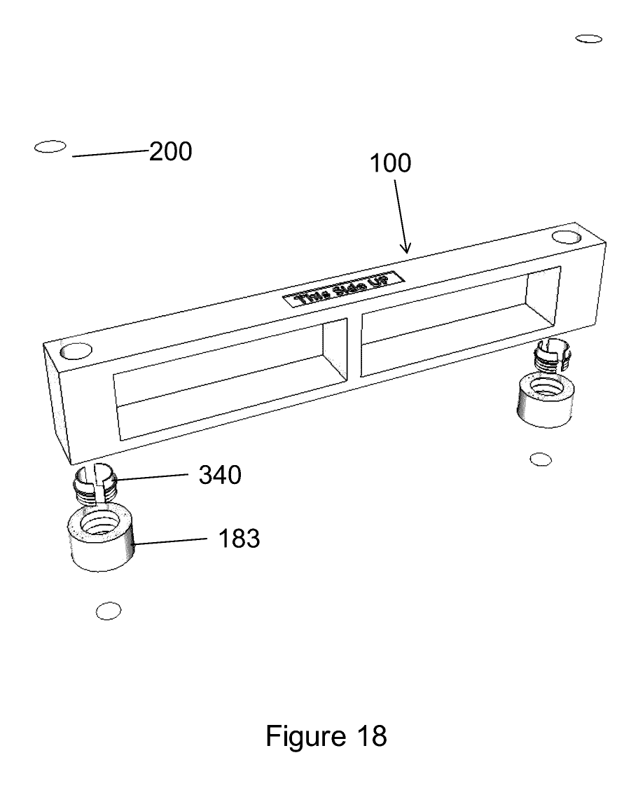

An exemplary embodiment of a two-piece collet-clamp is provided in FIGS. 17 and 18 of the attached drawings. FIG. 17, Panel A provides upper perspective view of an exemplary two-piece collet clamp (340) comprising two symmetrical halves while Panel B provides an internal cross sectional view of one half-of the collet-clamp (340). As illustrated the lower portion of the collet-clamp (342) provides a taper-threaded portion that engages the threads of a taper-threaded collar (not shown) that when tightened applies compressive force such that the interior surfaces of the collet-clamp (345) are compressed against the vertical support. FIG. 18 provides an additional illustration of the collet clamp frame locating means (340) in association with a frame (100), vertical supports (200) and threaded collars (183).

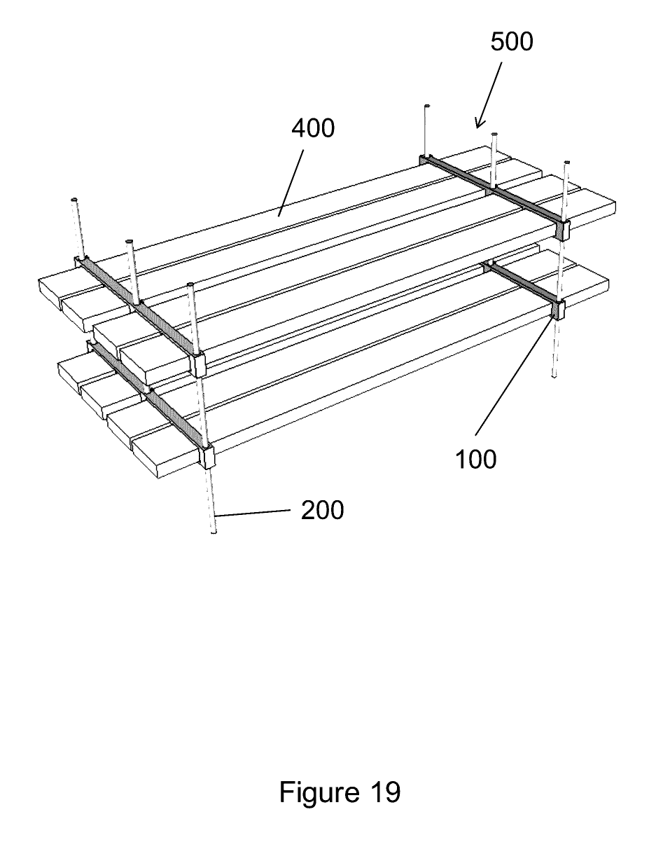

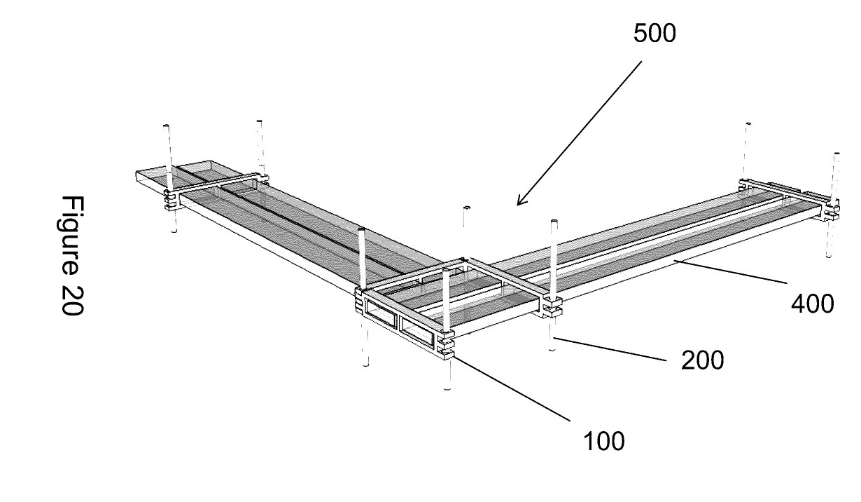

The present invention may be employed to create an elevated platform, said platform comprising at least one vertical support, at least one frame, at least one board, and at least one frame locating means. One embodiment of a elevated platform system (500) illustration of such a shelving system is provided in FIG. 19 of the attached drawings. As illustrated, the elevated platform system (500) comprises four frames (100), six vertical supports (200) and eight boards (400), and frame locating means (not shown). An additional embodiment of an elevated platform system of the present invention is provided in FIG. 20 illustrating the ability of the frames of the present invention to create elevated platform systems that go around corners. As illustrated in FIG. 20, the elevated platform system (500) is comprised of five frames (100), eight vertical supports (200) and four boards (400), the intersection of the frames with the vertical support incorporating a frame locating means (not shown).

The present invention further provides a kit of parts comprising at least one frame, said frame comprising at least one transverse aperture and at least one vertical support aperture, said transverse aperture configured to closely receive at least one board and instructions for use, said kit optionally providing one or more or the group consisting of frame locating means, vertical supports and/or boards. The present invention provides a kit of parts comprising at least one frame and instructions for use. The present invention further provides a kit of parts comprising at least one frame, at least one frame locating means and instructions for use. The present invention further provides a kit of parts comprising at least one frame, at least one frame locating means, at least one vertical support and instructions for use. The present invention further provides a kit of parts comprising at least one frame, at least one frame locating means, at least one vertical support, at least one board and instructions for use. The present invention further provides a kit of parts comprising at least one frame and at least one board and instructions for use. The present invention further provides a kit of parts comprising at least one frame and at least one vertical support and instructions for use. The present invention further provides a kit of parts comprising at least one frame, at least one frame locating means, at least one board and instructions for use. The present invention further provides a kit of parts comprising at least one frame, at least one vertical support, at least one board, and instructions for use.

The kits of the present invention may further provide one or more reinforcing means comprising structures to interconnect multiple frames so as to maintain the vertical supports in a substantially vertical position. Such reinforcing means provide additional resistance to distortion of the elevated platform by shear forces. In one embodiment of the invention, the rear face of the frame incorporates a structure to receive and anchor a wire. The wire or cable may be provided with one or more ferrules that are received into a tapered recess in the rear face of the frame which serves to interlock multiple frames with respect to one another creating an elevated platform system having enhanced stability and/or resistance to shear forces.

We claim:

1. A frame, said frame comprising at least one transverse aperture and at least one vertical support aperture, said transverse aperture configured to closely receive at least one board.

2. The frame of claim 1 wherein at least a portion of said vertical support aperture of said frame has a frustoconical inner surface.

3. The frame of claim 1 wherein said frame comprises at least two vertical support apertures.

4. The frame of claim 3 wherein said frame further comprises at least one transverse reinforcing aperture.

5. The frame of claim 1 wherein said frame incorporates one or more internal reinforcing structures.

6. The frame of claim 1 wherein said frame is comprised of two or more subassemblies.

7. An apparatus, said apparatus comprising a frame, said frame comprising at least one transverse aperture and at least one vertical support aperture, said transverse aperture configured to closely receive at least one board, and a frame locating means.

8. The apparatus of claim 7, wherein said frame locating means is selected from the group consisting of one or more pins, set-screws, clamps, collets, split collets, axial clamps and collet clamps.

9. The apparatus of claim 8 wherein at least a portion of a vertical support aperture of said frame has a frustoconical inner surface and said frame locating means is selected from the group consisting of one or more collets, split collets, and collet clamps.

10. The apparatus of claim 7, wherein said frame locating means is one or more set screws.

11. The apparatus of claim 7 wherein said frame is comprised of two or more subassemblies and wherein said frame locating means is one or more clamps.

12. The apparatus of claim 7 further comprising a transverse reinforcing aperture.

13. The apparatus of claim 7, said frame comprising two or more vertical support apertures.

14. The apparatus of claim 7, said apparatus further comprising at least one vertical support.

15. The apparatus of claim 14 wherein said vertical support is a substantially cylindrical tube.

16. The apparatus of claim 15 further comprising at least one board.

17. A kit of parts comprising at least one frame, said frame comprising at least one transverse aperture and at least one vertical support aperture, said transverse aperture configured to closely receive at least one board and instructions for use.

18. The kit of claim 17 further comprising one or more frame locating means.

19. The kit of claim 18 further comprising one or more vertical supports.

20. The kit of claim 19 further comprising one or more boards.
